(19) United States
(12) Patent Application Publication
(10) Pub. No.: US 2022/0082072 A1
(43) Pub. Date: Mar. 17, 2022

(54) Metal Diaphragm Metal Damper and Fuel Pump Provided With Same

(71) Applicant: Hitachi Astemo, Ltd., Hitachinaka-shi, Ibaraki (JP)

(72) Inventors: Satoshi USUI, Hitachinaka-shi, Ibaraki (JP); Hiroyuki YAMADA, Hitachinaka-shi, Ibaraki (JP)

(21) Appl. No.: 17/423,573

(22) PCT Filed: Feb. 5, 2020
(86) PCT No.: PCT/JP2020/004246

§ 371 Date: Jul. 16, 2021

(30) Foreign Application Priority Data
Feb. 13, 2019 (JP) 2019-023120

(51) Int. Cl. F02M 59/46; F04B 53/14; F04B 53/10

(52) U.S. Cl. CPC F02M 59/466; F04B 53/10; F04B 53/14

(57) ABSTRACT

Provided is a metal diaphragm that can be easily processed and manufactured at low cost. Therefore, a metal diaphragm (91, 92) of the present invention is configured such that a curvature radius r1 of a first curved portion 911 located on the outermost side in the radial direction (outer side in the left-right direction in FIG. 5) is minimized among a flange portion (91a, 92a) and curved portions (911, 912) that are located on the radially inner side of the flange portion (91a, 92a) and curved from the flange portion (91a, 92a) to one side (upper side in FIG. 5).

### TECHNICAL FIELD

The present invention relates to a metal diaphragm, a metal damper, and a fuel pump provided with the same regarding vehicle parts.

### BACKGROUND ART

In a direct injection type engine that directly injects fuel into a combustion chamber of an engine (internal combustion engine) of an automobile or the like, a high-pressure fuel supply pump configured to increase the pressure of the fuel has been widely used. An example of conventional techniques of such a high-pressure fuel supply pump is illustrated in JP 2009-540206 A (PTL 1). In FIG. 8 of PTL 1, regarding an electromagnetic drive device, it is disclosed that “the sagging of diaphragm shells 14 and 15 is limited by a stroke limiter 16, and the stroke limiter 16 includes a first hoop element 17 and a second hoop element 18. Both the hoop elements have a C-shaped profile, so that each of the hoop elements in diametrically opposite directions meet the inside of the diaphragm shells 14 and 15 and thereby limit the stroke of the diaphragm shells 14 and 15. Conversely, the hoop elements 17 and 18 mesh with one another when the pressure in chambers 21 and 22 drops, and the diaphragm shells 14 and 15 bulge outward” (see paragraph 0026).

### CITATION LIST

### Patent Literature

PTL 1: JP 2009-540206 A

### SUMMARY OF INVENTION

### Technical Problem

In the above-described related art, a plurality of curved portions having a small curvature radius are formed on the radial outer side of the diaphragm shells 14 and 15. When the plurality of curved portions having the small curvature radius are formed in this manner, pressing becomes difficult.

Therefore, an object of the present invention is to provide a metal diaphragm that can be easily processed and manufactured at low cost.

### Solution to Problem

In order to solve the above-described problems, a metal diaphragm of the present invention is configured such that a curvature radius r1 of a first curved portion located on the outermost side in the radial direction (outer side in the left-right direction in FIG. 5) is minimized among a flange portion and curved portions that are located on the radially inner side of the flange portion and curved to one side (upper side in FIG. 5) from the flange portion.

### Advantageous Effects of Invention

According to the present invention configured as described above, it is possible to provide the metal diaphragm that can be easily processed and manufactured at low cost.

Other configurations, operations, and effects of the present invention other than the content described above will be described in detail in the following embodiments.

### BRIEF DESCRIPTION OF DRAWINGS

FIG. 1 illustrates a block diagram of an engine system to which a fuel pump is applied.

FIG. 2 is a vertical cross-sectional view of the fuel pump.

FIG. 3 is a horizontal cross-sectional view of the fuel pump as viewed from above.

FIG. 4 is a vertical cross-sectional view of the fuel pump as viewed from a different direction from FIG. 2.

FIG. 5 is a view illustrating an axial cross-sectional view of a pressure pulsation reduction mechanism 9 (metal damper) of the present embodiment.

FIG. 6 is an axial cross-sectional view of the metal damper 9 of the present embodiment and is a view illustrating a state where each metal diaphragm (91, 92) vertically expands and contracts.

FIG. 7 is a view illustrating a bird's-eye view around the metal damper 9 of the present embodiment.

FIG. 8 is an exploded view of parts around the metal damper 9 of the present embodiment.

### DESCRIPTION OF EMBODIMENTS

Hereinafter, an embodiment of the present invention will be described with reference to the drawings.

### Embodiment

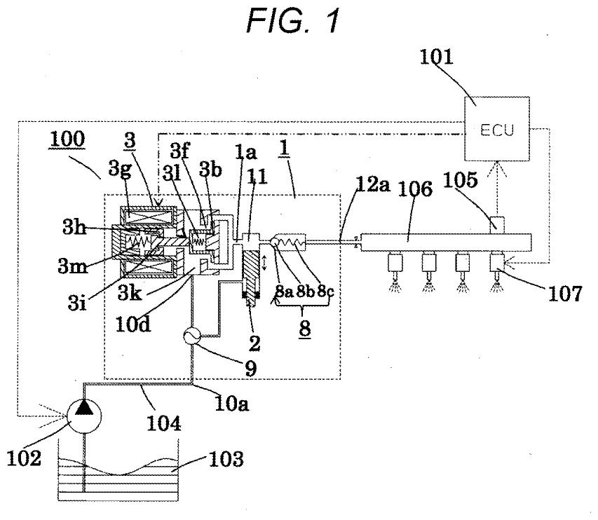

First, an embodiment of the present invention will be described in detail with reference to FIGS. 1 to 7.

A configuration and an operation of a system will be described using an overall configuration diagram of an engine system illustrated in FIG. 1.

A portion surrounded by a broken line indicates a main body of a high-pressure fuel pump (hereinafter referred to as the fuel pump) 100, and mechanisms and parts illustrated in this broken line are integrally incorporated in a body 1 (which may be also referred to as a pump body).

Fuel in a fuel tank 102 is pumped up from a fuel tank 103 by a feed pump 102 based on a signal from an engine control unit 101 (hereinafter referred to as the ECU). This fuel is pressurized to an appropriate feed pressure and sent to a low-pressure fuel intake port 10a of the fuel pump 100 through a fuel pipe 104.

The fuel flowing from the low-pressure fuel intake port 10a of the intake pipe 5 (not illustrated in FIG. 1) reaches an intake port 31 of an electromagnetic intake valve mechanism 3 which is a capacity-variable mechanism via a metal damper 9 and an intake passage 10d.

The fuel that has flowed into the electromagnetic intake valve mechanism 3 passes through the intake valve 3b, flows through an intake passage 1a formed in the body 1, and then, flows into a pressurizing chamber 11. A cam mechanism 91 of the engine applies motive power for a reciprocating motion to a plunger 2. Due to the reciprocating motion of the plunger 2, fuel is sucked from the intake valve 3b in a descending stroke of the plunger 2, and the fuel is pressurized in an ascending stroke thereof. When the pressure in the pressurizing chamber 11 exceeds a set value, a discharge valve mechanism 8 is open, and the high-pressure fuel is pumped to a common rail 106 on which a pressure sensor 105 is mounted. Then, an injector 107 injects fuel to the engine based on a signal from the ECU 101. The present embodiment relates to the fuel pump which is applied to a so-called direct injection engine system in which the injector 107 injects fuel directly into a cylinder barrel of the engine. The fuel pump 100 discharges a desired fuel flow rate of the supplied fuel based on the signal from the ECU 101 to the electromagnetic intake valve mechanism 3.

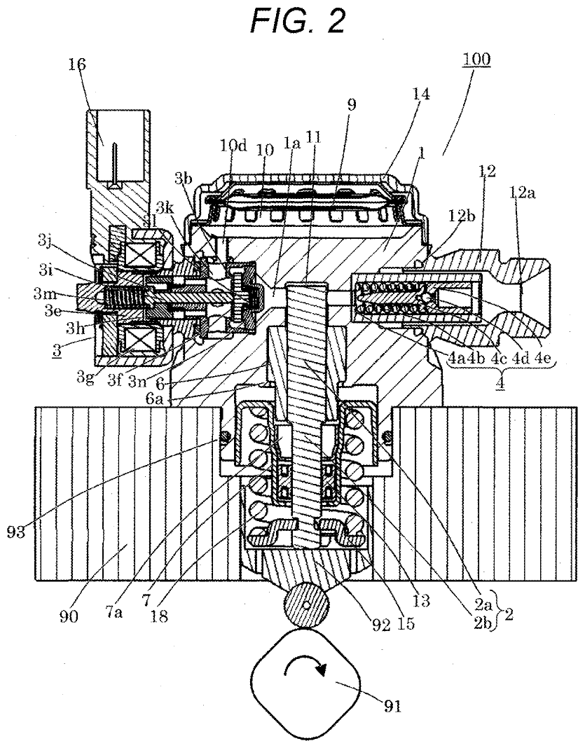

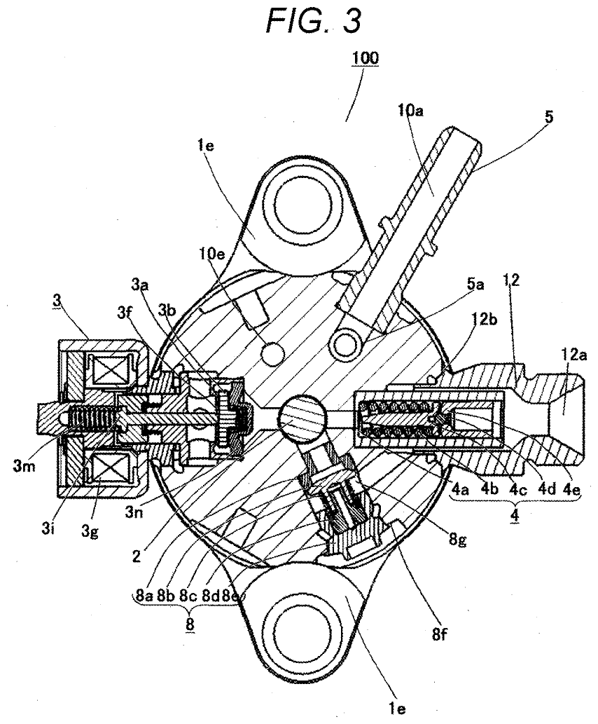

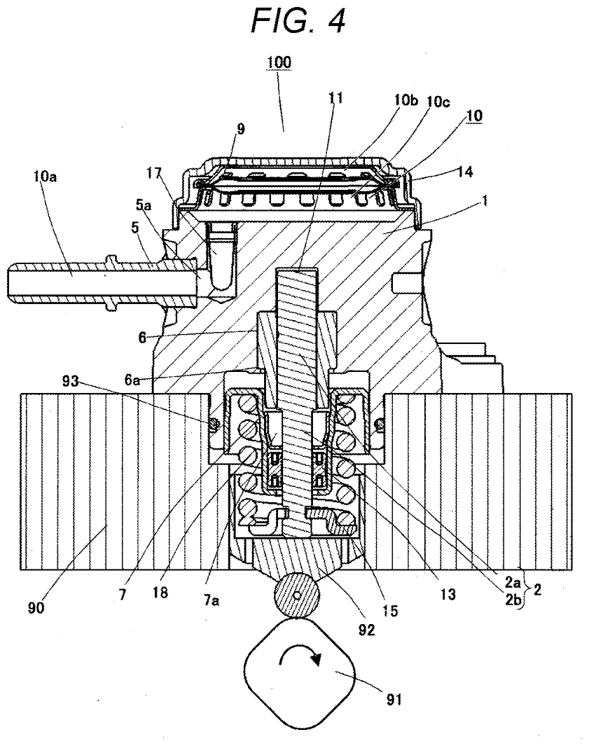

FIG. 2 illustrates a vertical cross-sectional view of the fuel pump 100 of the present embodiment as viewed in a cross section along the vertical direction, and FIG. 3 is a horizontal cross-sectional view of the fuel pump 100 as viewed from above. In addition, FIG. 4 is a vertical cross-sectional view of the fuel pump 100 as viewed in a vertical cross-section different from that of FIG. 2.

The fuel pump 100 of the present embodiment comes into close contact with a fuel pump mounting portion 90 (FIGS. 2 and 4) of the engine (internal combustion engine) using a mounting flange 1e (FIG. 3) provided on the body 1 and is fixed with a plurality of bolts (not illustrated).

In order for seal between the fuel pump mounting portion 90 and the body 1 as illustrated in FIGS. 2 and 4, an O-ring 93 is fitted into the body 1 to prevent engine oil from leaking to the outside.

A cylinder 6, which guides the reciprocating motion of the plunger 2 and forms the pressurizing chamber 11 together with the body 1, is attached to the body 1 as illustrated in FIGS. 2 and 4. In addition, the electromagnetic intake valve mechanism 3 configured to supply fuel to the pressurizing chamber 11 and the discharge valve mechanism 8 configured to discharge the fuel from the pressurizing chamber 11 to a discharge passage are provided.

The cylinder 6 is press-fitted into the body 1 on its outer circumference side. In addition, as the body 1 is deformed toward the inner circumference (radially inward), a fixed portion 6a of the cylinder 6 is pressed upward in the drawing, and the fuel pressurized in the pressurizing chamber 11 is sealed on an upper end surface of the cylinder 6 so as not to leak to the low pressure side. That is, the pressurizing chamber 11 is constituted by the body 1, the electromagnetic intake valve mechanism 3, the plunger 2, the cylinder 6, and the discharge valve mechanism 8.

A tappet 92, which converts a rotational motion of the cam 91 attached to a camshaft of the engine into an up-and-down motion and transmits the converted motion to the plunger 2, is provided at a lower end of the plunger 2. The plunger 2 is crimped to the tappet 92 by a spring 18 via a retainer 15. As a result, the plunger 2 can reciprocate up and down along with the rotational motion of the cam 91.

In addition, the plunger seal 13 held at a lower end of an inner circumference of a seal holder 7 is installed in the state of being slidably in contact with an outer circumference of the plunger 2 at a lower portion of the cylinder 6 in the drawing. As a result, when the plunger 2 slides, the fuel of an auxiliary chamber 7a is sealed to be prevented from flowing into the engine. At the same time, lubricating oil (including engine oil) lubricating a sliding portion in the engine is prevented from flowing into the body 1.

The relief valve mechanism 4 illustrated in FIGS. 2 and 3 is constituted by a seat member 4e, a relief valve 4d, a relief valve holder 4c, a relief spring 4b, and a spring support member 4a. The spring support member 4a also functions as a relief body that includes the relief spring 4b and forms a relief valve chamber. The spring support member 4a (relief body) of the relief valve mechanism 4 is press-fitted into and fixed to a lateral hole formed in the body 1. The relief spring 4b abuts on the spring support member 4a on one end side, and abuts on the relief valve holder 4c on the other end side. The relief valve 4d is pressed against a relief valve seat (the seat member 4e) by action of a biasing force of the relief spring 4b via the relief valve holder 4c, thereby blocking the fuel. A valve opening pressure of the relief valve 4d is determined by the biasing force of the relief spring 4b. In the present embodiment, the relief valve mechanism 4 communicates with the pressurizing chamber 11 via a relief passage, but is not limited thereto, and may communicate with a low-pressure passage (the low-pressure fuel chamber 10, the intake passage 10d, or the like).

The relief valve mechanism 4 is configured such that the relief valve 4d is open against the biasing force of the relief spring 4b when some problems occur in the common rail 106 and members beyond the common rail 106 so that the common rail 106 becomes abnormally high pressure and a differential pressure between the upstream side and the downstream side of the relief valve 4d exceeds a set pressure. The relief valve mechanism 4 has a role of opening the valve when the pressure in the common rail 106 and the members beyond the common rail 106 becomes high, and returning the fuel to the pressurizing chamber 11 or the low-pressure passage (low-pressure fuel chamber 10, the intake passage 10d, or the like).

As illustrated in FIGS. 3 and 4, the intake pipe 5 is attached to a side surface of the body 1 of the fuel pump 100. The intake pipe 5 is connected to a low-pressure pipe 104 that supplies fuel from the fuel tank 103 of a vehicle, and the fuel is supplied to the inside of the fuel pump from the intake pipe 5. An intake filter 17 in an intake flow path 5a at the tip of the intake pipe 5 serves to prevent foreign matters present between the fuel tank 103 and the low-pressure fuel intake port 10a from being absorbed into the fuel pump by the flow of fuel.

As illustrated in FIG. 4, the fuel that has passed through the low-pressure fuel intake port 10a flows into the low-pressure fuel chamber 10 (damper chamber) in which the metal damper 9 is arranged. Then, the fuel whose pressure pulsation has been reduced in the low-pressure fuel chamber 10 (damper chamber) reaches an intake port 3k of the electromagnetic intake valve mechanism 3 via a low-pressure fuel flow path 10d as illustrated in FIG. 2.

In an intake stroke in which the plunger 2 moves in the direction of the cam 91 by the rotation of the cam 91 as illustrated in FIGS. 2 and 3, the volume of the pressurizing chamber 11 increases so that the fuel pressure in the pressurizing chamber 11 decreases. In the intake stroke, an electromagnetic coil 3g is in a non-energized state, and the rod 3i is biased in the valve opening direction (to the right in FIGS. 2 and 3) by a rod biasing spring 3, so that an anchor 3h is biased by a distal portion of the rod 3i. In this stroke, if the fuel pressure in the pressurizing chamber 11 becomes lower than the pressure of the intake port 3k and a biasing force of the rod biasing spring 3 becomes larger than a front-rear differential pressure of the intake valve 3b, the intake valve 3b is separated from an intake valve seat portion 3a is turned into the open valve state. As a result, the fuel passes through an opening 3f of the intake valve 3b and flows into the pressurizing chamber 11. Incidentally, the rod 3i biased by the rod biasing spring 3 collides with a stopper 3n, and the operation in the valve opening direction is restricted.

After the plunger 2 finishes the intake stroke, the plunger 2 turns to upward movement and shifts to the ascending stroke. Here, the electromagnetic coil 3g is maintained in a non-energized state, and a magnetic biasing force does not act. A rod biasing spring 3m is set to have a sufficient biasing force to keep the intake valve 3b open in the non-energized state. Although the volume of the pressurizing chamber 11 decreases along with the compression movement of the plunger 2, the fuel, once taken into the pressurizing chamber 11, returns to the intake passage 10d through an opening 3f of the intake valve 3b in the open valve state again in this state, the pressure of the pressurizing chamber does not increase. This stroke is referred to as a return stroke.

In this state, when a control signal from the engine control unit 101 (hereinafter referred to as the ECU) is applied to the electromagnetic intake valve mechanism 3, a current flows through a terminal 16 to the electromagnetic coil 3g. When a current flows to the electromagnetic coil 3g, a magnetic attractive force acts between a magnetic core 3e and the anchor 3h, and the magnetic core 3e and the anchor 3h come into contact with each other on a magnetic attraction surface. The magnetic attractive force overcomes the biasing force of the rod biasing spring 3m to bias the anchor 3h, and the anchor 3h is engaged with a rod convex portion 3j to move the rod 3i in a direction away from the intake valve 3b.

Accordingly, the intake valve 3b is closed by a biasing force of an intake valve biasing spring 3l and a fluid force generated by the fuel flowing into the intake passage 10d. After the valve is closed, the fuel pressure of the pressurizing chamber 11 increases along with the upward movement of the plunger 2 to be equal to or higher than the pressure of a fuel discharge port 12a, the fuel is discharged at a high pressure through the discharge valve mechanism 8 and is supplied to the common rail 106. This stroke is referred to as a discharge stroke. Incidentally, a discharge joint 12 is inserted into the lateral hole of the body 1, and the fuel discharge port 12a is formed by an internal space of the discharge joint 12. Incidentally, the discharge joint 12 is fixed to the lateral hole of the body 1 by welding of a welded portion 12b.

That is, the ascending stroke between a lower start point and an upper start point of the plunger 2 includes the return stroke and the discharge stroke. Then, it is possible to control the amount of the high-pressure fuel to be discharged by controlling a timing of energization to the coil 3g of the electromagnetic intake valve mechanism 3. When the electromagnetic coil 3g is energized at an early timing, the proportion of the return stroke is small and the proportion of the discharge stroke is large during the ascending stroke.

That is, the amount of fuel returning to the intake passage 10d is small, and the amount of fuel to be discharged at a high pressure becomes large. On the other hand, if the energization timing is delayed, the proportion of the return stroke is large and the proportion of the discharge stroke is small during the ascending stroke. That is, the amount of fuel returning to the intake passage 10d is large, and the amount of fuel to be discharged at a high pressure becomes small. The energization timing to the electromagnetic coil 3g is controlled by a command from the ECU 101.

Since the energization timing to the electromagnetic coil 3g is controlled as described above, it is possible to control the amount of fuel to be discharged at a high pressure to the amount required by the engine. The discharge valve mechanism 8 on the outlet side of the pressurizing chamber 11 of the body 1 is constituted by a discharge valve seat 8a, a discharge valve 8b, which comes into contact with or separates from the discharge valve seat 8a, a discharge valve spring 8c biasing the discharge valve 8b toward the discharge valve seat 8a, and a discharge valve stopper 8d defining a stroke (movement distance) of the discharge valve 8b. The discharge valve stopper 8d is press-fitted into a plug 8e that blocks the leakage of fuel to the outside. The plug 8e is joined by welding at a welded portion 8f. A discharge valve chamber 8g is formed on the secondary side of the discharge valve 8b, and the discharge valve chamber 8g communicates with the fuel discharge port 12a through a horizontal hole formed in the body 1 in the horizontal direction.

In a state where there is no pressure difference of fuel between the pressurizing chamber 11 and the discharge valve chamber 8g, the discharge valve 8b is crimped against the discharge valve seat 8a by a biasing force of the discharge valve spring 8c and is turned into a closed valve state. The discharge valve 8b is open against the biasing force of the discharge valve spring 8c only when the fuel pressure in the pressurizing chamber 11 becomes larger than the fuel pressure in the discharge valve chamber 8g. When the discharge valve 8b is open, the high-pressure fuel in the pressurizing chamber 11 is discharged to the common rail 106 (see FIG. 1) via the discharge valve chamber 8g and the fuel discharge port 12a. With the above-described configuration, the discharge valve mechanism 8 functions as a check valve that restricts a flowing direction of the fuel.

The low-pressure fuel chamber 10 is provided with the metal damper 9 that reduces the influence of the pressure pulsation, generated in the fuel pump, to the fuel pipe 104. When the fuel, which has once flown into the pressurizing chamber 11, is returned to the intake passage 10d again through the intake valve body 3b that is in the open valve state for capacity control, the pressure pulsation occurs in the low-pressure fuel chamber 10 due to the fuel returned to the intake passage 10d. However, the metal damper 9 provided in the low-pressure fuel chamber 10 is formed of a metal diaphragm damper, which is formed by affixing two corrugated disk-shaped metal plates together at outer circumferences thereof and injecting an inert gas such as argon into the inside thereof, and the pressure pulsation is reduced by absorption by expansion and contraction of this metal damper. Incidentally, it is possible to obtain an effect that it is easy to check for gas leakage during manufacturing by filling the inside of the metal damper 9 with helium together with argon.

The plunger 2 has a large-diameter portion 2a and a small-diameter portion 2b, and the volume of the auxiliary chamber 7a is increased or decreased by the reciprocating motion of the plunger. The auxiliary chamber 7a communicates with the low-pressure fuel chamber 10 through a fuel passage 10e. The flow of fuel is generated from the auxiliary chamber 7a to the low-pressure fuel chamber 10 when the plunger 2 descends, and is generated from the low-pressure fuel chamber 10 to the auxiliary chamber 7a when the plunger 2 ascends.

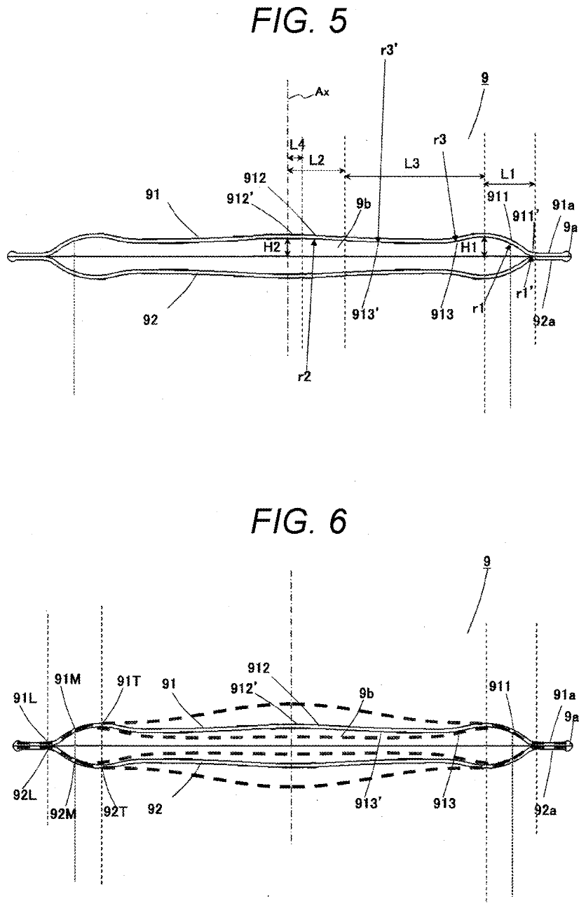

As a result, it is possible to reduce a fuel flow rate to the inside or outside of the pump in the intake stroke or return stroke of the fuel pump so as to serve a function of reducing the pressure pulsation that occurs inside the fuel pump. Hereinafter, the present embodiment will be specifically described with reference to FIGS. 5, 6 and 7.

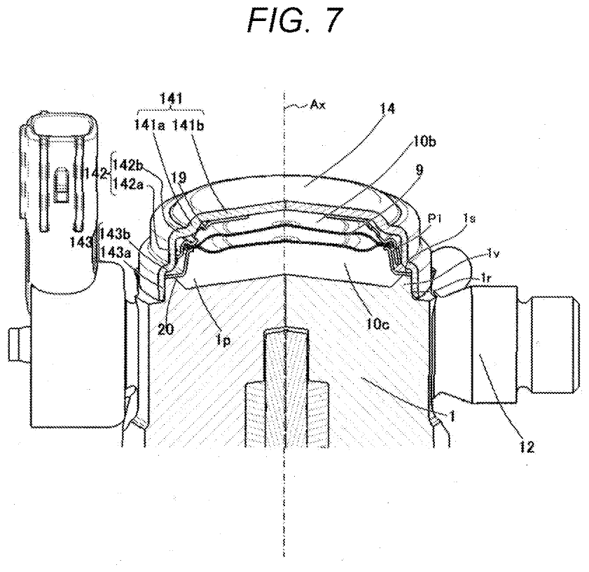

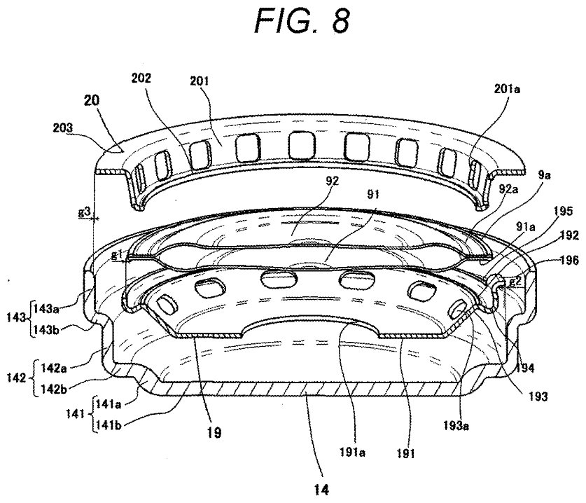

FIG. 5 illustrates an axial cross-sectional view of a pressure pulsation reduction mechanism 9 (metal damper) of the present embodiment, FIG. 6 is an axial sectional view of the metal damper 9 of the present embodiment which illustrates a state where each metal diaphragm (91, 92) vertically expands and contracts, FIG. 7 illustrates a bird's-eye view around the metal damper 9, and FIG. 8 illustrates an exploded view of parts around the metal damper 9. The metal damper 9 includes: a first metal diaphragm 91 and a second metal diaphragm 92 each of which has an internal space filled with an inert gas and has a substantially circular shape in a plan view; and the welded portion 9a for welding the first metal diaphragm 91 and the second metal diaphragm 92 on a peripheral edge. Annular and planar flat plate portions (flange portions) 91a and 92a extending in the radial direction are formed between the first metal diaphragm 91 and the welded portion 9a and between the second metal diaphragm 92 and the welded portion 9a, respectively. The flat plate portions 91a and 92a of the two metal diaphragms overlap each other, and these are located on the radially inner side of the welded portion 9a. The metal damper 9 is configured to reduce the pressure pulsation by increasing or decreasing the volume of an internal space 9b between the first metal diaphragm 91 and the second metal diaphragm 92 depending on the pressure acting on both sides.

A concave portion 1p of the pump body 1 is formed in a truncated cone shape whose diameter increases on the opening side. An outer peripheral surface 1r of the end of the pump body 1 on the concave portion 1p side is formed in a cylindrical surface shape, and an end surface 1s is formed in an annular shape. In other words, an annular protrusion 1v is formed at the end of the pump body 1 on the concave portion 1p side. The end of the pump body 1 on the concave portion 1p side and the concave portion 1p have rotationally symmetric shapes.

A damper cover 14 is formed in, for example, a rotationally symmetric shape with a stepped tubular shape (cup shape) closed on one side, and is configured to be capable of accommodating three parts of a first holding member 19, the metal damper 9, and a second holding member 20. The damper cover 14 is formed in a stepped tubular shape having a plurality of steps in a direction along a central axis Ax, and includes a first tubular portion 141a, a second tubular portion 142a, and a third tubular portion 143a. A radius (diameter) of each tubular portion is largest in the third tubular portion 143a, and then, decreases in the order of the second tubular portion 142a and the first tubular portion 141a. That is, the respective tubular portions are arranged in order of the third tubular portion 143a, the second tubular portion 142a, and the first tubular portion 141a from the radially outer side.

A third connecting portion 143b that connects the third tubular portion 143a and the second tubular portion 142a is formed between the third tubular portion 143a and the second tubular portion 142a. The third connecting portion 143b extends in the radial direction from the third tubular portion 143a toward the second tubular portion 142a, and forms a third radially extending portion (third stepped portion) that is a stepped portion between the third tubular portion 143a and the second tubular portion 142a.

A second connecting portion 142b that connects the second tubular portion 142a and the first tubular portion 141a is formed between the second tubular portion 142a and the first tubular portion 141a. The second connecting portion 142b extends in the radial direction from the second tubular portion 142a toward the first tubular portion 141a, and forms a second radially extending portion (second stepped portion) that is a stepped portion between the second tubular portion 142a and the first tubular portion 141a.

A first radially extending portion 141b, which extends in the radial direction from the first tubular portion 141a toward the center (central axis Ax) of the first tubular portion 141a, is formed at an upper end of the first tubular portion 141a (an end opposite to the second tubular portion 142a side). The first radially extending portion 141b forms a circular closing portion 141b that closes one end (upper end) of the damper cover 14 and is orthogonal to the central axis Ax.

The third tubular portion 143a has a longer length in the direction along the central axis Ax than the first tubular portion 141a and the second tubular portion 142a, and forms a cylindrical surface with a constant radius along the central axis Ax. The first tubular portion 141a is configured as a tapered surface whose diameter decreases from the second connecting portion 142b side to the first connecting portion 141b side.

The first tubular portion 141a and the first radially extending portion (closing portion) 141b form a first recessed portion (first step) 141. The first tubular portion 141a forms a side wall of the first recessed portion 141, and the first radially extending portion 141b forms a bottom of the first recessed portion 141.

The second tubular portion 142a and the second radially extending portion (second stepped portion) 142b form a second recessed portion (second step) 142. The second tubular portion 142a forms a side wall of the second recessed portion 142, and the second radially extending portion 142b forms a bottom of the second recessed portion 142.

The third tubular portion 143a and the third radially extending portion (third stepped portion) 143b form a third recessed portion (third step) 143. The third tubular portion 143a forms a side wall of the third recessed portion 143, and the third radially extending portion 143b forms a bottom of the third recessed portion 143.

The first recessed portion 141 is provided at the deepest position of the damper cover 14 having the bottomed tubular shape, and the first radially extending portion (closing portion) 141b of the first recessed portion 141 forms the deepest bottom. The third recessed portion 143 is provided on the opening side of the damper cover 14 having the bottomed tubular shape, and forms an opening of the damper cover 14. Incidentally, the central axis Ax coincides with a central axis of the plunger 2, and this central axis Ax is set as a central axis of the pump body 1.

The damper cover 14 is molded by pressing a steel plate, for example. The third tubular portion 143a of the damper cover 14 is press-fitted to the outer peripheral surface 1r at the end of the pump body 1 on the concave portion 1p side and fixed by welding. The damper cover 14 is provided with a plurality of steps on the tubular portion, and thus, can reduce a size of a distal portion (the first tubular portion 141a) with respect to a portion (the third tubular portion 143a) attached to the pump body 1, which is advantageous when an installation space for the high-pressure fuel supply pump is narrow.

The first holding member 19 is an elastic body having a bottomed tubular shape (cup shape) and a rotationally symmetric shape as illustrated in FIG. 8. Incidentally, FIG. 8 illustrates an assembly process, and thus, the vertical direction thereof is opposite to that of FIG. 7. Specifically, the first holding member 19 includes: an abutment portion 191 that abuts on a lower surface of the first radially extending portion 141b of the damper cover 14; an annular pressing portion (abutment portion) 192 that presses the flat plate portions (91a and 92a) of the metal damper 9 over the entire circumference; a tapered first side wall surface portion (tapered portion) 193 that connects the abutment portion 191 and the pressing portion 192 and expands in diameter from the abutment portion 191 toward the pressing portion 192; an annular curved portion 194 that protrudes radially outward from the entire circumference of the pressing portion 192 and is curved so as to be capable of receiving a part of the welded portion 9a of the metal damper 9; and a cylindrical enclosing portion 195 that extends in the axial direction from the curved portion 194 toward the concave portion 1p and surrounds the peripheral edge of the metal damper 9. The first holding member 19 is molded by pressing a steel plate, for example.

The abutment portion 191 forms a damper-cover-side abutment portion which abuts on the damper cover 14 side, and the pressing portion 192 forms a damper-member-side abutment portion which abuts on the metal damper (damper member) 9 side. The abutment portion 191 is formed on the radially inner side of the pressing portion 192. In addition, the first side wall surface portion 193 and the abutment portion 191 are formed on the radially inner side of the pressing portion 192, and forms a recessed portion of the first holding member 19 (first holding member recessed portion) that is recessed toward the side opposite to the side of the metal damper 9.

The abutment portion 191 is formed in a circular and planar shape. A first communication hole 191a is provided at the center of the abutment portion 191. In the present embodiment, it is also possible to adopt a configuration in which the first communication hole 191a is not provided. The first side wall surface portion 193 is provided with a plurality of holes (second communication holes) 193a at intervals in the circumferential direction. The second communication hole 193a is a communication path (through-hole) that communicates with a space formed on the radially inner side of the tapered first side wall surface portion 193 (space surrounded by the first holding member 19 and the metal damper 9) and a space formed on the radially outer side of the first side wall surface portion 193 (space surrounded by the first holding member 19 and the damper cover 14) and functions as a flow path that enables the fuel in the low-pressure fuel chamber (damper chamber) 10 to flow to both sides of the body portion 91 of the metal damper 9.

The enclosing portion 195 is set such that its inner diameter has a gap (first gap) g1 (see FIG. 8) within a predetermined range from an outer diameter of the metal damper 9, and functions as a first restricting portion that restricts the radial movement of the metal damper 9. The first gap g1 between an inner peripheral surface of the enclosing portion 195 and the peripheral edge of the metal damper 9 is set in a range where the pressing portion 192 of the first holding member 19 does not come into contact with the welded portion 9a of the metal damper 9 even if the metal damper 9 is radially displaced relative to the first holding member 19 by the first gap g1.

A plurality of protruding portions 196 protruding radially outward are provided at intervals in the circumferential direction on an opening-side end (lower end) of the enclosing portion 195. The plurality of protruding portions 196 are configured to face an inner peripheral surface of the second tubular portion 142a of the damper cover 14 with a gap (second gap) g2 (see FIG. 8) within a predetermined range, and function as a second restricting portion that restricts radial movement of the first holding member 19 inside the low-pressure fuel chamber (damper chamber) 10. In other words, the plurality of protruding portions 196 have a function of aligning the center of the first holding member 19 inside the damper cover 14. In order to fully exert the center alignment function, it is desirable to provide six or more protruding portions 196. The second gap g2 between a distal end of each of the protruding portions 196 and an inner peripheral surface of the second tubular portion 142a of the damper cover 14 is set in a range where the pressing portion 192 of the first holding member 19 does not come into contact with the welded portion 9a of the metal damper 9 even if the first holding member 19 is radially displaced from the damper cover 14 by the second gap g2.

Each of the protruding portions 196 is molded, for example, by cutting and raising, and a space P1 (see FIG. 7) extending in the circumferential direction is formed between the adjacent protruding portions 196. This space P1 forms a communication path that communicates with a space on one side (the upper side in FIG. 7) and a space on the other side (the lower side in FIG. 7) of the metal damper 9, and functions as a flow path that enables the fuel in the low-pressure fuel chamber (damper chamber) 10 to flow to both sides of a first diaphragm 91 and a second diaphragm 92. Even if the length of the protruding portion 196 is made as short as possible, the space P1 serving as the flow path can be reliably secured between the adjacent protruding portions 196, and thus, the first holding member 19 can be reduced in size in the radial direction.

The second holding member 20 is an elastic body having a tubular and rotationally symmetric shape, for example, as illustrated in FIG. 8. Specifically, the second holding member 20 is constituted by a tubular second side wall surface portion 201 which expands in diameter on one side (lower end side, and the upper side in FIG. 8), an annular pressing portion 202 bent radially inward from an upper end on the small diameter side of the second side wall surface portion 201, and an annular flange portion 203 protruding radially outward from a lower end on the large diameter side of the second side wall surface portion 201. The second holding member 20 is molded by pressing a steel plate, for example.

The second side wall surface portion 201 is provided with a plurality of third communication holes 201a at intervals in the circumferential direction.

The third communication hole 201a is a communication path that communicates with a space formed on the radially inner side of the tubular second side wall surface portion 201 (space surrounded by the second holding member 20, the metal damper 9, and the concave portion 1p of the pump body 1) P2 and a space formed on the radially outer side of the second side wall surface portion 201 (space surrounded by the second holding member 20 and the damper cover 14) P3, and functions as a flow path that enables the fuel in the low-pressure fuel chamber (damper chamber) 10 to flow to both sides of a body portion 91 of the metal damper 9.

The pressing portion 202 is configured to press the flat plate portions (91a and 92a) of the metal damper 9 over the entire circumference, and is formed to have the substantially same diameter as the pressing portion 202 of the first holding member 19. That is, the pressing portion 202 of the second holding member 20 and the pressing portion 192 of the first holding member 19 are configured to sandwich both sides of the flat plate portions (91a and 92a) of the metal damper 9 in the same manner.

The flange portion 203 is configured to abut on the end surface 1s of the pump body 1 on the concave portion 1p side from above. In addition, the flange portion 203 is configured to face an inner peripheral surface of a large-diameter tubular portion 143a of the damper cover 14 with a gap (third gap) g3 within a predetermined range, and functions as a third restricting portion that restricts radial movement of the second holding member 20 inside the low-pressure fuel chamber (damper chamber) 10. In other words, the flange portion 203 has a function of aligning the center of the second holding member 20 inside the damper cover 14. The third gap g3 between an outer peripheral edge of the flange portion 203 and an inner peripheral surface of a fourth tubular portion 144a of the damper cover 14 is set in a range where the pressing portion 202 of the second holding member 20 does not come into contact with the welded portion 9a of the metal damper 9 even if the second holding member 20 is radially displaced from the damper cover 14 by the third gap g3.

in this manner, the second communication hole 193a of the first side wall surface portion 193 of the first holding member 19, the space P1 formed between the adjacent protruding portions 196 of the first holding member 19, and the third communication hole 201a of the second side wall surface portion 201 of the second holding member 20 enable the fuel in the low-pressure fuel chamber 10 to flow through both sides of the metal damper 9. Therefore, it is unnecessary to provide the flow paths in the pump body 1, and the shapes of the pump body 1 and the concave portion 1p of the pump body 1 can be simplified into the rotationally symmetric shape.

In this case, it is unnecessary to process the flow paths on the pump body 1, and the pump body 1 and the concave portion 1p of the pump body 1 can be easily processed. Therefore, it is possible to reduce the manufacturing cost of the high-pressure fuel supply pump.

In addition, it is unnecessary to provide the pump body 1 with a structure for positioning (center alignment) of the first holding member 19, the metal damper 9, and the second holding member 20 according to the present embodiment. Therefore, the shape of the pump body 1 can be prevented from becoming complicated, and the shapes of the pump body 1 and the concave portion 1p of the pump body 1 can be simplified into the rotationally symmetric shape.

In addition, according to the present embodiment, the abutment area of the abutment portion 191 with the damper cover 14 can be reduced, and the outer diameter of the metal damper 9 can be increased. As a result, it is possible to suppress the vibration transmitted from the pump body 1 and the metal damper 9 to the damper cover 14 via the first holding member 19 in the state of enhancing the damper performance of the metal damper 9. That is, it is possible to suppress the vibration transmission in a vibration transmission path to the damper cover 14 via the first holding member 19.

(Metal Damper Assembling Process) Next, a process of assembling the metal damper in the high-pressure fuel supply pump according to the present embodiment will be described with reference to FIG. 8.

First, the damper cover 14 is arranged such that the closing portion 141b is located on the lower side and the opening is located on the upper side as illustrated in FIG. 8.

Next, the first holding member 19 is inserted into the damper cover 14 with the abutment portion 191 facing downward, and placed on the closing portion 141b of the damper cover 14. At this time, the first holding member 19 is positioned in the radial direction inside the damper cover 14 by the plurality of protruding portions 196 thereof.

That is, the center of the first holding member 19 is aligned inside the damper cover 14 only by inserting the first holding member 19 into the damper cover 14. Since the second gap g2 is provided between the protruding portion 196 of the first holding member 19 and the inner peripheral surface of the second tubular portion 142a of the damper cover 14 in the present embodiment, the first holding member 19 is easily assembled with the damper cover 14.

Next, the metal damper 9 is placed on the pressing portion 192 of the first holding member 19 inside the damper cover 14. At this time, the metal damper 9 is positioned in the radial direction inside the first holding member 19 by the enclosing portion 195 of the first holding member 19. In this case, the center of the first holding member 19 has been aligned inside the damper cover 14, and thus, the center of the metal damper 9 is aligned inside the damper cover 14 only by placing the metal damper 9 on the first holding member 19. Since the first gap g1 is provided between the inner peripheral surface of the enclosing portion 195 of the first holding member 19 and the peripheral edge of the metal damper 9 in the present embodiment, the metal damper 9 is easily assembled with the first holding member 19.

Subsequently, the second holding member 20 is inserted into the damper cover 14 with the pressing portion 202 facing downward, and placed on the flat plate portions (91a and 92a) of the metal damper 9. At this time, the second holding member 20 is positioned in the radial direction inside the damper cover 14 by the flange portion 203 thereof. That is, the center of the second holding member 20 is aligned inside the damper cover 14 only by inserting the second holding member 20 into the damper cover 14. Since the third gap g3 is provided between the outer edge of the flange portion 203 of the second holding member 20 and the inner peripheral surface of the large-diameter tubular portion 143a of the damper cover 14 in the present embodiment, the second holding member 20 is easily assembled with the damper cover 14.

Finally, the end of the pump body 1 (see FIG. 7) on the concave portion 1p side is press-fitted into the third tubular portion 143a of the damper cover 14 to form a state where the end surface 1s of the pump body 1 on the concave portion 1p side presses the flange portion 203 of the second holding member 20. In this state, the damper cover 14 is fixed to the pump body 1 by welding.

In this case, the flange portion 203 and the second side wall surface portion 201 of the second holding member 20 are elastically bent. In addition, the abutment portion 191 of the first holding member 19 is pressed by the second radially extending portion 142b of the second recessed portion 142 of the damper cover 14, and the first side wall surface portion 193 of the first holding member 19 is elastically bent. As a result, spring reaction forces are generated in the first holding member 19 and the second holding member 20, and the metal damper 9 is reliably held in the low-pressure fuel chamber (damper chamber) 10 by biasing forces generated by these reaction forces.

In this manner, it is possible to perform positioning (center alignment) of the first holding member 19, the metal damper 9, and the second holding member 20 inside the damper cover 14 only by inserting the first holding member 19, the metal damper 9, and the second holding member 20 into the damper cover 14 in the process of assembling the metal damper 9 according to the present embodiment. Therefore, a process for positioning each of the parts 9, 19, and 20 becomes unnecessary.

In addition, it is unnecessary to unitize the three parts of the first holding member 19, the metal damper 9, and the second holding member 20 for the assembly with the damper cover 14, and thus, a sub-assembly process of unitizing these parts 9, 19, and 20 is not necessary.

Furthermore, the damper cover 14, the first holding member 19, the metal damper 9, and the second holding member are formed into the rotationally symmetric shapes, respectively, it is only necessary to pay attention to the axial orientations of these parts at the time of assembly. Therefore, it is possible to improve the productivity and reduce the cost by simplifying the assembly process.

Here, the metal diaphragm (91, 92) of the present embodiment is configured such that a curvature radius r1 of a first curved portion 911 located on the outermost side in the radial direction (outer side in the left-right direction in FIG. 5) is minimized among a flange portion (91a, 92a) and curved portions (911, 912) that are located on the radially inner side of the flange portion (91a, 92a) and curved from the flange portion (91a, 92a) to one side (upper side in FIG. 5). The metal diaphragm (91, 92) reduces the pressure pulsation by vertically expanding and contracting when the pressure is applied. Incidentally, each of the curved portions (911, 912, 913) is formed so as to have the same radial length and circumferential shape when the metal diaphragm is viewed from the axial direction. However, a portion of the first curved portion 911 located on the outermost side in the radial direction on the flange portion (91a, 92a) side hardly contributes to the reduction of pressure pulsation.

FIG. 6 is an axial cross-sectional view of the metal damper 9 of the present embodiment which illustrates a state where each of the metal diaphragms (91, 92) vertically expands and contracts. Specifically, a dashed line in the radial direction indicates the state where the metal diaphragm (91, 92) vertically expands and contracts. Here, the metal diaphragm (91, 92) has a lower end (91L, 92L) at which the inclination starts and an upper end (91T, 92T) at which the position in the axial direction is highest. An intermediate portion (91M, 92M) indicates the middle position between the lower end (91L, 92L) and the upper end (91T, 92T) in the radial direction. As indicated by the dashed line in the radial direction, it is illustrated that the portion of the metal diaphragm (91, 92) that actually expands and contracts in the vertical direction is the radially inner side of the intermediate portion (91M, 92M). The portion on the radially inner side of the intermediate portion (91M, 92M) hardly contributes to the reduction of pressure pulsation.

Therefore, it is desirable that the metal diaphragm (91, 92) of the present embodiment be configured such that the curvature radius r1 of the first curved portion 911 located on the outermost side in the radial direction is minimized among the curved portions (911, 912, 912′, 913, 913′) that are located on the radially inner side of the intermediate portions (91M, 92M) between the lower ends (91L, 92L) from which the inclination starts and the upper ends (91T, 92T) having the highest axial positions.

With these configurations, it is possible to widen a substantially movable region in the radial direction by reducing the portion that hardly contributes to the pressure pulsation, and thus, the pressure pulsation reduction effect can be improved. In addition, when the curvature radius r1 of the first curved portion 911 located on the outermost side in the radial direction is minimized, the curvature radius (r2, r3) of the curved portion (912, 913) on the radially inner side of the first curved portion 911 is larger than the curvature radius r1. That is, the bending degree of the curved portion (912, 913) becomes gentle, it is possible to easily perform the pressing and to improve the pressure pulsation reduction effect as compared with the metal damper in which the curved portion is not formed.

In the present embodiment, the first curved portion 911 has a curved portion having a curvature radius r1′ on the radially outer side and a curved portion having the maximum curvature radius r1 larger than the curvature radius r1′. In addition, the second curved portion 912 has a curved portion having a planar portion 912′ with an infinite curvature radius on the radially inner side and a curved portion having the minimum curvature radius r2 smaller than the curvature radius of the planar portion 912′. That is, the second curved portion 912 is defined as the second curved portion including the planar portion 912′ in the present embodiment. However, any curved portion may be defined as one curved portion when the curved portion that curves in the opposite direction to the second curved portion 912 is not formed even if the planar portion 912′ is not formed.

When the curved portion (911, 912) has the plurality of curvature radii in this manner, the maximum curvature radius r1 of the first curved portion 911 is configured to be minimized with respect to the minimum curvature radius r2 of the second curved portion 912 that is curved from the flange portion (91a, 92a) to the same side as the first curved portion 911.

Incidentally, it is desirable that the minimum curvature radius r2 of the second curved portion 912 be 3.5 to 5 times of the maximum curvature radius r1 of the first curved portion 911. As a result, it is possible to improve the pressure pulsation reduction effect as described above.

In addition, the metal diaphragm (91, 92) includes a third curved portion 913 that is located between the first curved portion 911 and the second curved portion 912 in the radial direction and curved from the first curved portion 911 to the opposite side (lower side in FIG. 5) of the first curved portion 911. In addition, the third curved portion 913 has a curved portion having a curvature radius r3′ on the radially inner side and a curved portion having a minimum curvature radius r3 which is a curvature radius smaller than the curvature radius r3′ on the radially outer side. Then, the maximum curvature radius r1 of the first curved portion 911 is configured to be minimized with respect to the minimum curvature radius r3 of the third curved portion 913. A smooth curvature can be obtained by making the curvature radius (r3, r3′) of the third curved portion 913 as large as possible, and as a result, the volume of the internal space 9b becomes small. Here, the pressure around the metal damper 9 is about 0.4 MPa in normal operation, but may be abnormally high, for example, 1.0 MPa or more in some cases. In such cases, if the volume of the internal space 9b is large, contraction occurs by that amount, and thus, there is a possibility that the internal pressure of the metal damper becomes too high. On the other hand, it is possible to prevent the internal pressure from becoming too high by reducing the volume of the internal space 9b according to the above configuration.

In addition, the metal diaphragm (91, 92) is configured such that a radial length L1 of the first curved portion 911 is smaller than a radial length L2 of the second curved portion 912 curved to the same side as the first curved portion 911. In addition, the metal diaphragm (91, 92) includes the third curved portion 913 that is located between the first curved portion 911 and the second curved portion 912 in the radial direction and curved from the first curved portion 911 to the opposite side of the first curved portion 911. Then, a radial length L3 of the third curved portion 913 is configured to be larger than the radial length L1 of the first curved portion 911 and the radial length L2 of the second curved portion 912. That is, since the radial length L1 of the first curved portion 911 is made as small as possible, it is possible to reduce the portion that is unlikely to contribute to the pressure pulsation, and it is possible to improve the pressure pulsation reduction effect.

In addition, the metal diaphragm (91, 92) includes the second curved portion 912, which is located on the radially inner side of the first curved portion 911 and curved from the first curved portion 911 to the same side as the first curved portion 911, and the third curved portion 913 which is located between the first curved portion 911 and the second curved portion 912 in the radial direction and curved from the first curved portion 911 to the opposite side of the first curved portion 911. Then, only the three curved portions including the first curved portion 911, the second curved portion 912, and the third curved portion 913 are formed between the flange portion (91a, 92a) and an axial center (central axis Ax) in the radial direction. Although a metal damper in which a large number of curved portions are formed is used in the related art, but stamping (pressing) becomes difficult if there are many curved portions. In particular, if hard metal is used to improve the durability of the metal damper, the pressing becomes more difficult, and thus, it is desirable to avoid a complicated shape as much as possible and to adopt a simple shape. However, since the configuration in which only the three curved portions are formed as described above is adopted in the present embodiment, it is possible to improve the durability of the metal damper using a hard material and to easily perform molding by pressing, so that the metal diaphragm (91, 92) can be manufactured at low cost.

As illustrated in FIG. 5, the second curved portion 912 is formed to include the axial center (central axis Ax) of the metal diaphragm (91, 92). In addition, in the metal diaphragm (91, 92), the second curved portion 912 has the planar portion 912′ formed in the direction orthogonal to the central axis Ax of the metal diaphragm (91, 92) on the radially inner side. Incidentally, a radial length L4 of the planar portion 912′ is formed to be about 0.1 to 0.4 times, that is, less than half of the radial length L2 of the second curved portion 912. Since the planar portion 912′ with this minute radial length is provided in the central portion, this planar portion 912′ collides with the planar portion of the opposing metal diaphragm (91, 92) when the above-described abnormal high pressure is applied to the metal diaphragm (91, 92), and thus, the internal volume 9b is not reduced any more. That is, it is possible to improve the durability of the metal diaphragm (91, 92).

In addition, the metal diaphragm (91, 92) has a plate thickness of 0.23 mm to 0.27 mm and is formed by press-molding. That is, the plate thickness can be reduced since the pressing can be easily performed while using the hard material as described above according to the present embodiment.

In addition, it is desirable that the metal diaphragm (91, 92) be configured such that an axial height H2 of the second curved portion 912 curved to the same side as the first curved portion 911 is smaller than an axial height H1 of the first curved portion 911. As a result, the volume of the internal space 9b can be reduced as described above, and it is possible to prevent the internal pressure from becoming too high. That is, the durability of the metal damper can be improved.

Further, it is desirable that the metal damper 9 be configured by joining the flange portions (91a, 92a) of the two metal diaphragms (91, 92) and that the two metal diaphragms (91, 92) have the same shape. As a result, it is possible to manufacture the metal damper at lower cost as compared with the case of adopting different metal diaphragms. In addition, it is desirable that the fuel pump 100 of the present embodiment include the plunger 2 that pressurizes the fuel in the pressurizing chamber 11 by reciprocating motion and the solenoid valve 3 arranged on the upstream side of the pressurizing chamber 11, and that the metal damper 9 described above be arranged on the upstream side of the solenoid valve 3.

### REFERENCE SIGNS LIST

1 body
2 plunger
3 electromagnetic intake valve mechanism
4 relief valve mechanism
5 intake pipe
6 cylinder
7 seal holder
8 discharge valve mechanism
9 metal damper
91 first metal diaphragm
92 second metal diaphragm
911 first curved portion
912 second curved portion
913 third curved portion
914 fourth curved portion
10 damper chamber
11 pressurizing chamber
12 discharge joint
13 plunger seal

1. A metal diaphragm comprising:
a flange portion; and
curved portions each of which is located on a radially inner side of the flange portion and curved to one side from the flange portion,
wherein a curvature radius r1 of a first curved portion located on an outermost side in a radial direction is minimized.

2. The metal diaphragm according to claim 1, wherein
when the curved portion has a plurality of curvature radii, a maximum curvature radius r1 of the first curved portion is minimized with respect to a minimum curvature radius r2 of a second curved portion that curves from the flange portion to a same side as the first curved portion.

3. The metal diaphragm according to claim 2, further comprising
a third curved portion that is located between the first curved portion and the second curved portion in the radial direction and curves from the first curved portion to an opposite side of the first curved portion,
wherein the maximum curvature radius r1 of the first curved portion is minimized with respect to a minimum curvature radius r3 of the third curved portion.

4. The metal diaphragm according to claim 1, wherein
a radial length L1 of the first curved portion is smaller than a radial length L2 of a second curved portion curved to a same side as the first curved portion.

5. The metal diaphragm according to claim 4, further comprising
a third curved portion that is located between the first curved portion and the second curved portion in the radial direction and curves from the first curved portion to an opposite side of the first curved portion,
wherein a radial length L3 of the third curved portion is larger than the radial length L1 of the first curved portion and the radial length L2 of the second curved portion.

6. The metal diaphragm according to claim 4, further comprising:
the second curved portion that is located on a radially inner side of the first curved portion and curved from the first curved portion to the same side as the first curved portion; and
a third curved portion that is located between the first curved portion and the second curved portion in the radial direction and curved from the first curved portion to an opposite side of the first curved portion,
wherein only three curved portions including the first curved portion, the second curved portion, and the third curved portion are formed between the flange portion and an axial center in the radial direction.

7. The metal diaphragm according to claim 6, wherein
the second curved portion is formed so as to include an axial center of the metal diaphragm.

8. The metal diaphragm according to claim 6, wherein
the second curved portion has a planar portion formed on an inner side in the radial direction in a direction orthogonal to a central axis Ax of the metal diaphragm.

9. The metal diaphragm according to claim 1,
the metal diaphragm has a thickness of 0.23 mm to 0.27 mm and is formed by press-molding.

10. The metal diaphragm according to claim 1, wherein
an axial height H2 of a second curved portion curved to a same side as the first curved portion is smaller than an axial height H1 of the first curved portion.

11. A metal damper configured by joining the flange portions of two metal diaphragm according to claim 1,
wherein the two metal diaphragms have an identical shape.

12. A high-pressure fuel pump comprising:
a plunger that pressurizes fuel in a pressurizing chamber by reciprocating motion; and
a solenoid valve arranged on an upstream side of the pressurizing chamber,
wherein the metal damper according to claim 11 is arranged on an upstream side of the solenoid valve.
